(19) United States
(12) Patent Application Publication
(10) Pub. No.: US 2010/0156607 A1
(43) Pub. Date: Jun. 24, 2010

(54) Method for activating an RFID antenna and an associated RFID antenna system

(76) Inventors: Thomas Lankes, Rosenheim (DE); Frank Mierke, Munchen (DE); Gerald Schillmeier, Munchen (DE)

Correspondence Address: NIXON & VANDERHYE, PC, 901 NORTH GLEBE ROAD, 11TH FLOOR, ARLINGTON, VA, 22203, US

(21) Appl. No.: 12/339,682

(22) Filed: Dec. 19, 2008

(51) Int. Cl. H04Q 5/22; H01Q 1/50

(52) U.S. Cl. 340/10.5; 343/850

(57) ABSTRACT

An improved method and an improved device for activating an RFID antenna uses an antenna (A) and an antenna network (N). The antenna (A) is operated via the antenna network (N) by means of a connectable reader (R). The antenna (A) is operated as a circular or elliptical polarized antenna (A) in such a way that it is alternately left-handed and right-handed polarized.

The invention relates to a method for activating an RFID antenna and an associated RFID antenna system as claimed in the preamble of the coordinated claims.

An RFID antenna system is already known, for example from DE 10 2007 018 059.

RFID methods for the contactless identification of information stored on what are known as RFID tags using magnetic, electric and/or electromagnetic power and data transmission are well-known. The RFID (radio frequency identification) method involves the possibility of contactlessly reading information contained in portable data carriers and/or writing information to portable date carriers. What are known as passive RFID tags which are always powered by the electric, magnetic and/or electromagnetic field of an antenna, or what are known as active RFID tags which are provided with their own (chargeable) power supply are used. RFID tags are generally what are known as transponders.

The RFID tags in question may be used for all kinds of application, in particular for sensing (detecting, identifying) a wide range of objects and/or products, for example for identifying and detecting items of clothing, for example T-shirts, etc.

It is known for RFID tags and the associated identification methods to be configured and implemented in such a way that a writing and/or reading device (what is known as a reader) is provided. The reader is connected to an antenna, by means of which the corresponding polling signals can be transmitted and the corresponding information answers from the tag can be received. An RFID method thus often involves transmitting and receiving on the same frequency (different frequencies may, however, also be used to transmit and receive). The signal transmitted by the antenna of the writing and/or reading device may at the same time power the tag. The corresponding information is read from the tag and sent back to the transmitter and/or receiver device which receives the corresponding signal via an associated antenna and evaluates said signal. In this instance, a bidirectional transmission-reception path in the same frequency range or frequency band is thus involved. In addition, different frequency bands may be provided in different countries for this method.

The main problem encountered with RFID systems is that of reading all tags present in an antenna range completely and correctly. A particular drawback is that a plurality of products which are provided with tags may possibly be arranged behind and/or next to one another within a small space in such a way that, under these circumstances, some tags may not be read correctly or completely, or may not be read at all.

It is thus known that the reading speed can be improved by amplifying the antenna signal. However, there are legal restrictions regarding the transmitting power of the reader. Since these legal restrictions regarding the transmitting power of the reader are based, however, on the linear field components of the antenna, circular polarized antennas are preferably used for the reader so as to be able to better pick up tags in different directions, despite the predominantly linear polarization thereof, and so as to be able to ultimately operate the circular polarized antenna with a higher total power output (for example a maximum of 3 dB) compared to a linear polarized RFID antenna. Owing to the undefined environment and tag arrangement, picking up the tags may, however, be strongly affected depending on direction.

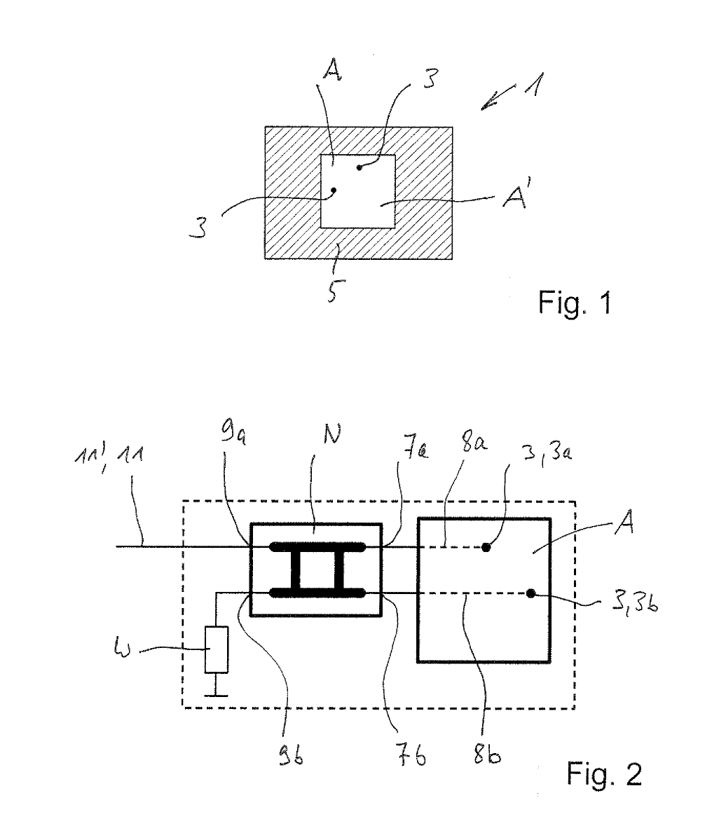

Predominantly circular polarized antennas are conventionally used as reader antennas. FIG. 1 is a schematic plan view of an antenna arrangement 1 of this type in the form of a patch antenna A which, for example, comprises two feeding points 3 which are offset at 90° from one another and are thus preferably arranged symmetrically about a diagonal extending through the square patch antenna A′ comprising an electrically conductive patch emitting area. With an assembly of this type, it is ultimately possible to produce a circular polarized electromagnetic wave. The antenna 1 known from the prior art and shown in FIG. 1 is in this case arranged, for example, on a substrate, for example in the form of a printed circuit board 5. The circular form of the electromagnetic wave generated via the patch antenna is in this case achieved at least by the two aforementioned feeding points 3 for the two orthogonal linear polarizations. The power distribution of approximately 50:50 required for this and the phase difference of 90° may be achieved using a corresponding network N, for example a π/2 hybrid, as is shown schematically in FIG. 2. The π/2 hybrid shown in FIG. 2 comprises two antenna ports 7a and 7b, it being possible to produce an electrical connection 8a and 8b to the two feeding points 3a and 3b. In accordance with the basic circuit as claimed in FIG. 2 and known from the prior art, the antenna network N is activated via an input port 9a, namely via a feed line 11 preferably in the form of a coaxial line 11′, which is connected to a reader R. The second input port 9b, i.e. overall the fourth port of the hybrid described, is conventionally closed with the wave impedance W of the line.

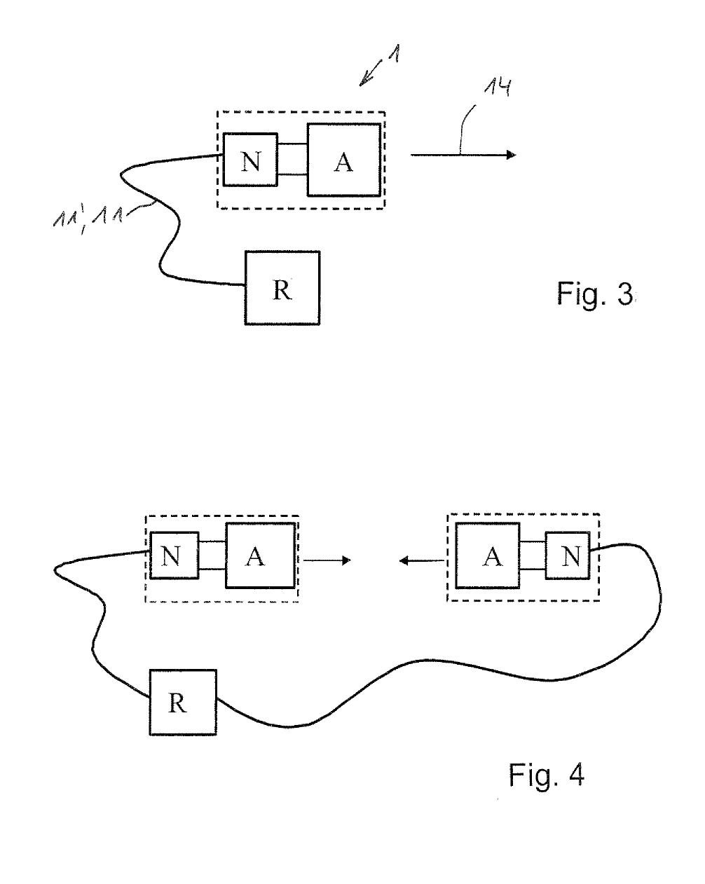

By using an antenna of this type, it is possible to produce either a left-circular polarized electromagnetic wave or a right-circular polarized wave which can be emitted in a direction of beam 14 which is shown schematically (FIG. 3). In practice, neither of the two polarization types has proved to be more advantageous than the other. A left-circular or right-circular polarized wave is accordingly produced in that the feed line 11 coming from the reader R is connected to one of the input ports 9a or 9b and the respective other input port is closed with the aforementioned wave impedance. Generally, a reader R of this type is used with the corresponding antenna network N and the reader antenna A as shown in FIG. 3, in particular in the field of automation. The reader R may, however, also be operated with two or more spatially separated antennas A so as to be able to monitor, for example, a larger predetermined region. In this case, the reader successively switches between the two identically polarized and spatially separated antennas A, as is shown schematically in FIG. 4.

Starting from a system of this type known in principle from the prior art, the object of the present invention is to provide an improved method and an improved device for the contactless transmission of data from and/or to a plurality of data and/or information carriers, preferably in the form of RFID tags.

With regard to the method, the object is achieved in accordance with the features disclosed in claim 1 and with regard to the RFID antenna system, in accordance with the features disclosed in claim 11. Advantageous embodiments of the invention are disclosed in the sub-claims.

It should be noted that, rather surprisingly, conventional methods and RFID antenna systems can be considerably improved at a low production cost. It is also surprising that, with the solution as claimed in the invention, the production cost does not increase disproportionately, nor do necessary components require any additional space.

As claimed in the invention, it is particularly provided for the reader antenna concerned to be activated and/or operated in such a way that the reader antenna produces and emits a left-circular and right-circular polarized electromagnetic wave alternately. Tag recognition is considerably improved just by alternating the direction of polarization. In this way, a wide range of, i.e. many different, types of tag may be used irrespective of the tag polarization. Above all the invention may thus also be used irrespective of the environment encountered in the respective field of application.

In a preferred embodiment of the invention, an antenna network arranged upstream of the RFID antenna is used, with which network the transmitting signal coming from the reader is alternately fed first to one of the input ports and then to the other input port, it thus being possible to alternately produce a left-handed and then a right-handed circular polarized electromagnetic wave and vice-versa. In this case, the respective other input port, i.e. the input or port, which is inactive, of the antenna network, is preferably closed with no reflection when viewed from the antenna network. A patch antenna is preferably used which comprises two feeding points which are alternately activated via the antenna network so as to produce the alternating left-circular and right-circular polarized electromagnetic wave. In this process, approximately 50% of the power is fed to one of the feeding points. The use of a patch antenna having four feeding points offset by 90° is also conceivable for example, in this case approximately 25% of the transmitting power preferably being fed to each individual feeding point.

This explanatory description reveals that the reader in question is connected, for example via two feeding lines preferably in the form of two coaxial lines, to the two antenna network port inputs so as to alternately transmit the transmitting signal to one of the input ports and so as to produce a left-circular or right-circular polarization at the reader antenna. The reader must thus be configured as claimed in the invention in such a way that the respective reader output which is inactive is closed with little reflection or preferably no reflection when viewed from the connected coaxial line. However, it is also possible for the antenna network to be supplemented with a further switching network which is only connected via a single connecting line, preferably also in the form of a coaxial cable, to the reader. The switching network thus connects the inputs of the antenna network through to the reader in a reader-controlled manner, for example via an intermediate frequency superposed with useful signal or a d.c. voltage, etc. At the same time, the respective input which has not been connected through is closed as above with no reflection. In this case, there are no specific requirements as to the impedance of the respective inactive reader output (should there be more than one).

The aforementioned antenna network and the reader antenna are preferably configured as a unit. The aforementioned switching network may be configured so as to form a common unit with the network and/or reader antenna or so as to be separate therefrom. If necessary, the reader itself may also be configured so as to form a common unit with the network and, optionally, with the switching network and the reader antenna.

The invention will be explained in greater detail hereinafter with reference to the drawings, in which:

FIG. 1: is a schematic plan view of a patch antenna known from the prior art, comprising two feeding points;

FIG. 2: shows a circuit arrangement known from the prior art, comprising a reader antenna which is activated via an antenna network in the form of a π/2 hybrid so as to produce a circular polarized electromagnetic wave;

FIG. 3: shows the corresponding activation of the circuit arrangement shown in FIG. 2, by a reader via a coaxial line as claimed in the prior art;

FIG. 4: shows a circuit arrangement as claimed in the prior art which has been extended compared with that shown in FIG. 3 and in which two reader antennas, each comprising an antenna network arranged upstream, are activated by one reader;

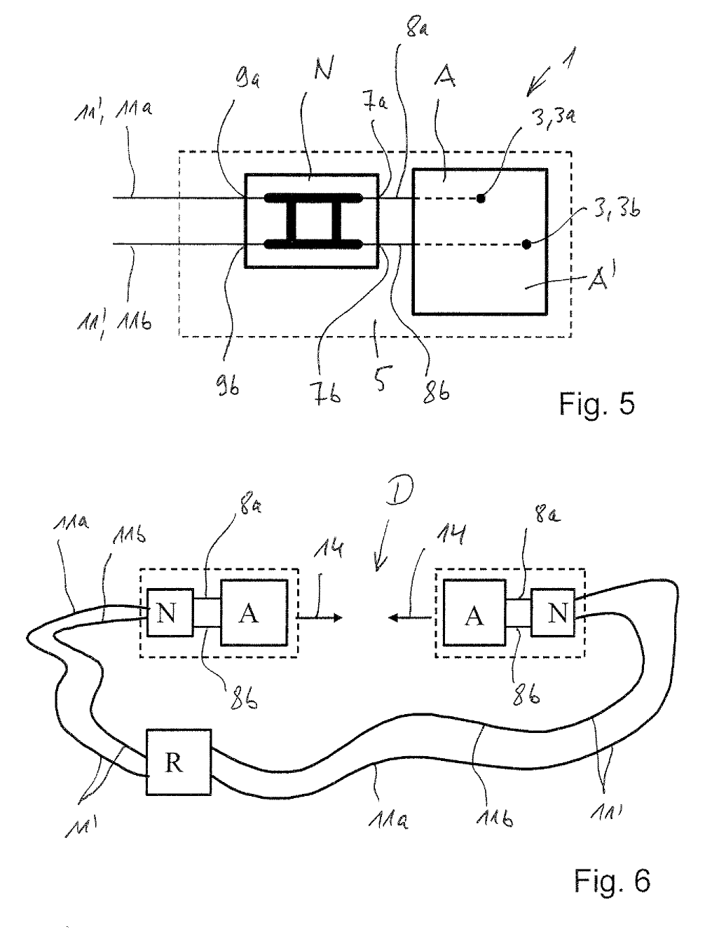

FIG. 5: shows a circuit arrangement as claimed in the invention of a reader antenna comprising an antenna network arranged upstream;

FIG. 6: shows an RFID antenna system as claimed in the invention;

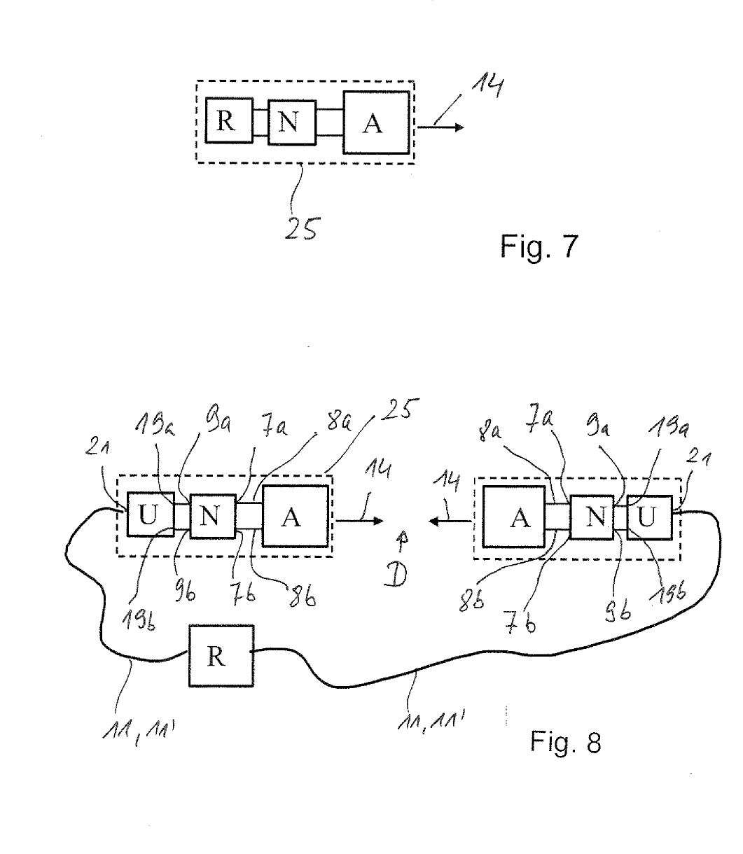

FIG. 7: shows an embodiment which has been modified compared to that shown in FIG. 6 and in which the reader antenna, a network and the reader itself are configured as a common unit;

FIG. 8: shows an embodiment as claimed in the invention which has again been modified compared to that shown in FIG. 6; and

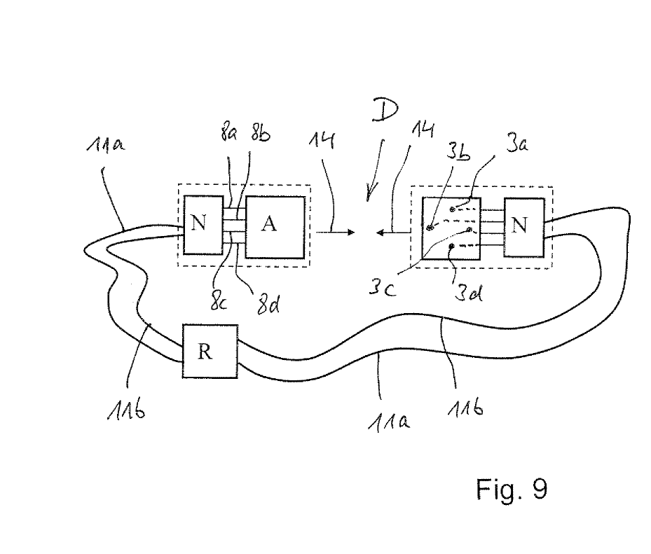

FIG. 9: shows an embodiment which has again been modified compared to that shown in FIG. 6 and comprises an antenna in the form of a patch antenna which is fed via four feeding points.

Reference will be made hereinafter to FIGS. 5 and 6, in which a first embodiment of the invention is shown.

In accordance with the invention, the antenna arrangement 1 in turn comprises an antenna A in the form of a patch antenna A′ having two feeding points 3, i.e. 3a and 3b. The antenna arrangement 1 also comprises, in addition to the antenna A, a π/2 network N which is explained with reference to FIGS. 1 and 2 and is connected via the two outputs 7a and 7b and the connecting lines 8a and 8b to the two feeding points 3 and thus feeds the patch antenna A′ in such a way that the transmitting signals coming from the reader R are thus fed into the antenna A and the signals emitted from the tag can be received and transmitted back to the reader R.

The π/2 network N comprises the two aforementioned input-side or reader-side ports 9a and 9b, two transmission or feed lines 11a and 11b now being provided, in contrast to the prior art, which lines lead to the reader R. In both cases coaxial feed lines 11′ are preferably used. This assembly makes it possible for the patch antenna 1 to first feed from the reader R via one of the feed lines 11a either in a timed manner or directly successively in an alternate manner, the respective other port 9b, i.e. the respective reader output which is inactive, being closed in the reader with no reflection when viewed from the antenna network. This may be achieved, for example, by a resistance W connected to earth (as shown in FIG. 2) in such a way that the line is conventionally terminated with the wave impedance of the line.

In a time-division multiplex system, for example, the feed is alternately switched over by the reader in such a way that the feed signal is no longer fed via the first port 9a, but via the second port 9b to the network N and thus to the patch antenna 1, and in this case the first line 9a is closed, preferably in accordance with the wave impedance of the line.

When feeding to the first terminal 9a, a left-handed circular polarized wave, for example, is emitted from the antenna, whereas when feeding to the second terminal 9b a right-handed circular polarization is produced and emitted. The time phases for switching can thus be selected and adjusted as desired within a wide range. Switching may occur, for example, at time intervals of approximately 8 ms. The switching times may, however, also be considerably longer at high communication speeds. In addition, rest periods may, in principle, be provided depending on the respective switching or transmission cycles.

In the case of an assembly of this type with a reader from which two feed lines extend, an antenna arrangement 1 may, for example, be operated alternately in such a way that alternating left-circular polarized and right-circular polarized electromagnetic waves are successively produced and emitted at a pre-selectable time interval, that is to say the antenna A concerned and, in particular, the patch antenna A′ is generally alternately operated as a left-handed circular polarized antenna and then as a right-handed circular polarized antenna. In the embodiment shown in FIG. 6, it is indicated, for example, that two pairs of feed lines 11, 11′ extend to two respective antennas A via a reader, more specifically over the aforementioned network N. An assembly as claimed in FIG. 6 is particularly suitable for monitoring a transmission region D which is arranged between the two antenna arrangements A. With the assembly as claimed in FIG. 6, it is thus possible, for the antenna arrangement arranged to the left of the transmission region D and subsequently the antenna arrangement arranged to the right of the transmission region D to be activated and operated by the reader R, said arrangements thus alternately operating in a left-circular and right-circular manner respectively.

It should also be noted that the transitions from the antenna network N, i.e. from the antenna arrangement 1, to the coaxial cable 11′ and from the cables 11′ to the reader R are configured so as to have no reflection or have as little reflection as possible.

The described antenna arrangement 1 and the operation thereof, including that of the reader R, are suitable for various frequency ranges. The antenna arrangement and use of a corresponding reader is particularly suitable and adapted for the UHF range, i.e. a frequency range of from 800 MHz to 1 GHz, in particular for the range of from 865 MHz to 868 MHz, or from 902 MHz to 928 MHz.

The object of UHF-RFID systems of this type is to achieve the highest reading speed (tag recognition) possible in a wide range of environments and with various tag arrangements, the majority of tags available generally being polarized in a linear polarized manner.

FIG. 7 merely shows that, for example in contrast to FIG. 6, the reader R can be integrated together with the patch antenna A, i.e. with the patch antenna 1 and the fed network N, in a housing 25. A left-circular and right-circular polarized electromagnetic wave can thus be produced alternately.

FIG. 8 is an alternate embodiment with regard to that shown in FIGS. 5 and 6 in that it shows a further switching network U arranged upstream of the actual network. Furthermore, each of the antenna arrangements comprising the network N and the switching network U arranged upstream A is activated and fed by a single line 11, in particular a single coaxial line 11′. This switching network U arranged upstream thus has only one reader-side terminal port 21 and only one connection, preferably in the form of a coaxial cable 11′, in which not only the corresponding feed signal but also, for example, an intermediate frequency superposed with useful signal or a d.c. voltage is fed via this cable 11′ as a further signal, which enables the switching network to correspondingly connect through from its input 21 on one of the two outputs 19a or 19b, and thus via the two connection lines 29a and 29b shown in FIG. 8, to the network N arranged downstream. A corresponding feed signal is thus fed to the network N, as in the embodiment shown in FIGS. 5 and 6, via only one port 9a or the other port 9b, whereas the respective other port 9b or 9a is correspondingly closed, in the switching network U with little or no reflection when viewed from the network N so as to produce right-circular or left-circular polarization, as described above. In an embodiment of this type with a switching network U, there are no specific requirements as to the impedance of the inactive reader outputs.

In the embodiment shown, the switching network is also housed in the common housing 25, the reader being provided separately in the embodiment shown although this does not have to be the case. The switching network may also be provided outside the housing 25, separate from the actual network N and the patch antenna 1.

FIG. 9 shows a final embodiment, in which an antenna, for example a patch antenna, comprising four feeding points, is used. In this case, the network N has four antenna-side ports 9a, 9b, 9c and 9d. Approximately 25% of the transmitting power is fed to each individual feeding point.

Taking into account all the embodiments, it should further be noted that, in general, any antenna having at least 2 feeding points may be used in such a way that two types of circular polarization (right-handed and left-handed) may be achieved. Patch antennas, turnstile aerials, slot aerials, loop antennas, etc, may thus be used, for example, as the antennas as claimed in the invention.

It is further noted that the antenna should not work or be operated only in a left-circular or right-circular polarized manner, but should generally produce a corresponding left-handed or right-handed elliptical polarization.

In this respect, circular polarization is only one specific type of elliptical polarization.

1. Method for activating an RFID antenna comprising:
an antenna and an antenna network, wherein the antenna is operated via the antenna network by means of a connectable reader,
wherein the antenna is operated as a circular or elliptical polarized antenna in such a way that it is alternately left-handed and right-handed polarized.

2. Method as claimed in claim 1, wherein the successive left-handed and right-handed polarization states follow one another directly or are produced alternately at a pre-determined time interval.

3. Method as claimed in claim 1, wherein the antenna comprises a patch antenna having feeding points that are activated alternately in such a way that left-handed and right-handed polarization is produced alternately at the patch antenna.

4. Method as claimed in claim 3, wherein the patch antenna comprises two feeding points, approximately 50% of the transmitting power preferably being fed to each of said points.

5. Method as claimed in claim 3, wherein the patch antenna has four feeding points is used, approximately 25% of the transmitting power preferably being fed to each of said points.

6. Method as claimed in any claim 1, further including an antenna network operatively coupled to the antenna and comprising two reader-side ports, a useful signal being fed first to one port and then to the other port of the antenna network via the connectable reader so as to alternately produce left-handed and right-handed polarization, and the respective inactive port is closed with little or no reflection when viewed from the antenna network.

7. Method as claimed in claim 6, wherein the antenna network and two reader-side ports associated therewith that are separately activated by two lines coming from the reader, and in that the respective inactive reader output is closed in the reader with little or no reflection when viewed from the antenna network.

8. Method as claimed in claim 1, further comprising a switching network which is connected upstream of an antenna network, the switching network connecting one of the feed-side ports of the antenna network through to the reader in a reader-controlled manner, and the respective port which has not been connected through preferably being closed in the switching network with little reflection or no reflection when viewed from the network.

9. Method as claimed in claim 8, wherein, in addition to a useful signal, a signal in the form of a superposed intermediate frequency or a d.c. voltage is fed to the reader-controlled switching network via the reader-side port thereof, as a function of which signal the useful signal is fed in a different manner to one of the feed-side ports of the antenna network arranged downstream, the connected antenna emitting in an alternately left-handed and right-handed circular polarized manner as a function thereof.

10. Method as claimed in claim 1, wherein the antenna comprises an RFID antenna in a UHF-frequency range, in particular in a frequency range of from 800 MHz to 1 GHz, in particular of from 865 MHz to 868 MHz or in particular from 902 MHz to 928 MHz.

11. RFID antenna system comprising:
a circular polarized antenna;
an antenna network for controlling and/or operating the antenna,
the antenna network comprising at least two antenna-side ports for feeding the antenna,
the antenna network comprising two reader-side ports, one of the ports being able to be connected or being connected via a line to a reader and the respective second port being closed with little reflection or no reflection,
the antenna network being configured in such a way that left-handed and right-handed polarization can be produced alternately via the at least two antenna-side ports.

12. RFID antenna system as claimed in claim 11, wherein the antenna can be activated via the antenna network, in a reader-controlled manner, in such a way that left-circular and right-circular polarization can be generated alternately so as to either follow one another directly or at a pre-determined time interval.

13. RFID antenna system as claimed in claim 11, wherein the antenna comprises at least two feeding points the antenna preferably consisting of a patch antenna, a turnstile aerial, a slot aerial or a loop antenna.

14. RFID antenna system as claimed in claim 13, wherein the antenna comprises two feeding points, to each of which at least approximately 50% of the transmitting power can be fed.

15. RFID antenna system as claimed in claim 13, wherein the antenna comprises four feeding points, to each of which at least approximately 25% of the transmitting power can preferably be fed.

16. RFID antenna system as claimed in claim 11, wherein the antenna network comprises two reader-side ports structured to first feed a useful signal via the connectable reader to a port of the antenna network and to the other port so as to alternately produce left-handed and right-handed polarization, the respective inactive port being capable of being closed with little reflection or no reflection when viewed from the antenna network.

17. RFID antenna system as claimed in claim 11, wherein the reader is connected via two lines, preferably in the form of coaxial lines, to the antenna network in such a way that one of the reader-side ports can be activated via a line and the respective other port can be closed in the reader with little reflection or no reflection and vice-versa, to operate the activated antenna while producing left-handed and right-handed polarization alternately.

18. RFID antenna system as claimed in claim 11, wherein a switching network is also provided which is connected upstream of the antenna network, structured to connect one of the feed-side ports of the antenna network through to a connectable reader by means of the switching network, in a reader-controlled manner, and to close the respective port which has not been connected through in the switching network with little reflection and preferably no reflection.

19. RFID antenna system as claimed in claim 18, wherein, in addition to a useful signal, a signal in the form of a superposed intermediate frequency or a d.c. voltage is fed via a line to the reader-controlled switching network via the reader-side port thereof in such a way that, as a function of said signal, the useful signal is fed in a different manner to one of the feed-side ports of the antenna network arranged downstream, as a function of which the connected antenna is in turn operated as a left-handed polarized or right-handed polarized antenna.

20. RFID antenna system as claimed in claim 11, wherein the antenna is provided as an RFID-antenna for use within a UHF-frequency range, in particular within a frequency range of from 800 MHz to 1 GHz, in particular of from 865 MHz to 868 MHz or from 902 MHz to 928 MHz.
